(19) United States
(12) Patent Application Publication
(10) Pub. No.: US 2003/0052068 A1
(43) Pub. Date: Mar. 20, 2003

(54) Separating system for hollow fiber membranes and operating method thereof

(76) Inventor: Xiao-Long Lu, Tianjin (CN)

Correspondence Address: Rabin & Berdo, P.C., Suite 500, 1101 14th Street, Washington, DC, 20005, US

(21) Appl. No.: 10/222,900

(22) Filed: Aug. 19, 2002

(30) Foreign Application Priority Data
Sep. 18, 2001 (CN) 01 1 41868.0

(51) Int. Cl. B01D 65/02; B01D 63/02

(52) U.S. Cl. 210/798; 210/108; 210/143; 210/321.69; 210/321.79

(57) ABSTRACT

The invention relates to a separating system with hollow fiber membranes and an operating method. A dual backwash loop which is a pipeline connecting a top port of the said membrane assembly to a cleaning pump through a first branch and a second branch. The first branch is designed to fill a small amount of cleaning liquid into the said membrane assembly; and the second branch is designed to fill a relatively large amount of cleaning liquid in order to clean the membrane adequately. The said system operates in the following procedures: operation status, cleaning status 1, cleaning status 2, drain status, returning to the operation status. The technology of the present invention may be used to enhance the cleaning effect to the membrane system, further save water for the cleaning process, shorten the cleaning time, thus benefiting the continuous large scale industrial production and having higher efficiency.

### BACKGROUND OF THE INVENTION

1. Field of the Invention

The present invention relates to a separation technique, especially an external-compression separating system for hollow fiber membranes and an operating method thereof.

2. Description of Related Art

Water is the source of life. With the improving living standards, on the one hand, people need more higher quality drinking water such as so-called pure water, space water or purified water in daily life. On the other hand, for water used in production and industrial purposes such as in biochemical, medical and pharmaceutical, food, and seasoning fields the demand on its pureness is setting higher and higher. In the recent years microfiltration and ultrafiltration membranes for water purification were developed to accommodate such situations, and have shown the better practical effect. Particularly, an external compression hollow fiber membrane is applied mostly. The reason is that the external compression hollow fiber membrane (hereinafter called the membrane) has the advantage of the largest specific area of filled membrane in unit volume to remove suspended matter such as the algae, microbe, and colloidal matter in original water, and higher purification level. However, in practical applications, the suspended matter will attach and accumulate in the cavity, pores, and on the external walls of the membrane resulting rapidly in degradation of its penetrability for water, and even blockage thereby causing failed operation. Therefore, cleaning of the membrane is an important part of the applied technology. Especially in the case of that at present the original water (including water from rivers, lakes, wells, sea and tap water) has been or is being polluted, effective cleaning of the membrane becomes significant.

The applicant has applied for many patents on cleaning technology for the membrane wherein the latest one is titled “Separating System for Hollow Fiber Membrane & Operating Method Thereof” (CN1333080A). The said patent describes the key innovation on construction of the membrane and the water flow line, and offers a solution for effective in-line cleaning. But there are still some shortcomings in the system: imperfect design of external pipelines for the membrane assembly, for example a lack of a chemically cleaning loop; not an ideal automatic operation control, e.g. need of manually operated backwash valves for opening, closing and desired openness thereof; there is still a margin to improve the cleaning effect, thus it will be necessary to innovate further.

### SUMMARY OF THE INVENTION

The principle object of the present invention is to provide a perfect solution directing against the shortcomings in the existing membrane systems on the pipeline and operation thereof. That solution may improve the cleaning effect of the membrane system, save water for the cleaning process, shorten cleaning time, bringing benefits and higher efficiency to the continuous industrial production.

A technical scheme of the solution of the present invention is: designing an external compression separation system for the hollow fiber membrane including a membrane assembly, control valves, pressure gauges, pumps, an air compressor, water tanks, and pipe lines connected, and in addition, a dual backwash loop which is connected from a top port of the membrane assembly to a cleaning pump (24) through a flow meter (27), a first branch, and a second branch respectively; wherein the first branch is designed to fill a smaller amount of cleaning liquid into the said membrane assembly (21) in combination with the membrane fiber cleaning function by vibration from compressed air; the second branch is designed to fill a relatively large amount of cleaning liquid in order to clean the membrane adequately.

Besides, the top port of the membrane assembly is connected to the cleaning pump through backwash valves and automatic backwash valves following the flow meter respectively, the cleaning pump is connected to a cleaning liquid tank (25) through an inlet valve of the cleaning pump and to a drain valve respectively; the said cleaning liquid tank (25) is connected to an outlet valve for filtered liquid to pass through a switchover valve and a flow meter for the filtered liquid; the pipe line between the switchover valve and the flow meter for the filtered liquid is connected to a cycle tank through the switchover.

Separating and cleaning processes may be performed ideally by utilizing the separating system for the membranes of the present invention and by the operating method of the present invention.

The said “operating method of the present invention” refers to the following procedures:

(1). Operating status of the separating system for the membrane:

Regulating valves (1,2) in the cycle line to present 0.05-0.20 MPa of an operating pressure P1 at the inlet of the membrane assembly, and 0.03-0.18 MPa at the outlet thereof, operating for 20-40 mins.;

(2). Cleaning status 1:

Controlling valves in the first branch of the dual backwash loop to obtain a flow rate of cleaning liquid, ¼-½ times as many as that of the filtered liquid, a reading of 0.2-6.0 Nm3/h in a gas flow meter (28); cleaning for 10-60 ; secs.;

(3). Cleaning status 2:

Controlling valves in the second branch of the dual backwash loop to achieve a flow rate of cleaning liquid, ½-2 times as many as that of the filtered liquid, cleaning for 20 secs.-2 mins.;

(4). Drain status

Closing the valves in the two branches of the dual backwash loop, draining for 5-60 secs.

(5). Returning to the operation status.

The technical scheme of the present invention for solution of the technical problems mentioned above is focused on the membrane system wherein perfecting the design of the external pipelines is included, specifically, a chemically cleaning loop, a dual backwash loop and a bypass loop are designed. The chemically cleaning loop refers mainly to the pipeline between the switchover valve 4 and the flow meter for filtered liquid 26 which is connected to the cycle tank 23 through the switchover valve 5. In comparison with the existing technology, such a design may enhance the effect of the membrane system cleaning. The so-called cleaning technology is itself an existing technology.

The dual backwash loop is a new design of the present invention wherein a top port of the membrane assembly 21 is connected to the cleaning pump 24 through the backwash valves 3, 3a and the automatic backwash valves 15, 15a following the flow meter 27. Such a design may have a backwash or cleaning process of two steps, i.e. cleaning status 1 and cleaning status 2. In the cleaning status 1, a smaller amount of cleaning liquid is filled into the said membrane assembly 21 through the valves 3a and 15a in combination with the membrane fiber cleaning function by vibration from compressed air; in the cleaning status 2, a relatively large amount of cleaning liquid is filled into the said membrane assembly 21 through the valves 3a and 15a to perform a from-top-to-bottom cleaning process causing further water saving and an enhanced effect of the membrane fiber and the membrane assembly cleaning.

The bypass loop is designed to connect the pipeline between the pump 22 and the pressure control valve 1 with the cycle tank 23 through a bypass valve 16. Such a loop is designed to protect the MF operating pump 22 (hereinafter called operating pump 22 or pump 22). As it is necessary to shut the pump 22 down while the control valve 11 is closed in the backwash or cleaning process; when returning to the operating status, the control valve 11 must be opened before the pump 22 is put into operation; so the alternative running condition of the membrane system and the in-line cleaning process will make the pump 22 to be switched On/Off frequently, that will not only shorten the service life of the pump 22, but also affect long-term operation of the membrane system. The bypass loop designed may always keep the pump 22 in its running condition during operation of the membrane system, thus, it will protect the pump 22 and raise operative efficiency as well.

In order to solve the potential problem on automatic operation control, the present invention adopts a design of valve combination, i.e. combination of a manually operated valve with an automatically operated valve, for example combination of the control valve 1 with the automatic valve 11 at the inlet, of the valve 2 with the automatic valve 19 at the outlet, of the backwash valve 3 with the automatic backwash valve 15, and of the backwash valve 3a with the automatic backwash valve 15a. These manually operated valves are used to control manually openness or flow rate thereof (it is possible to preset before starting, or control during operation), those automatically operated valves are used to control automatically the switchover of corresponding pipelines. The control automation will increase the level of continuous operation and ensure the stability and the reliability of the membrane system.

### BRIEF DESCRIPTION OF THE DRAWINGS

FIG. 1 is a schematic diagram of a complete membrane system of the present invention.

### DETAILED DESCRIPTION OF THE PREFERRED EMBODIMENT

Detailed description of the present invention is given below by referring to the drawing and specific examples of the embodiment:

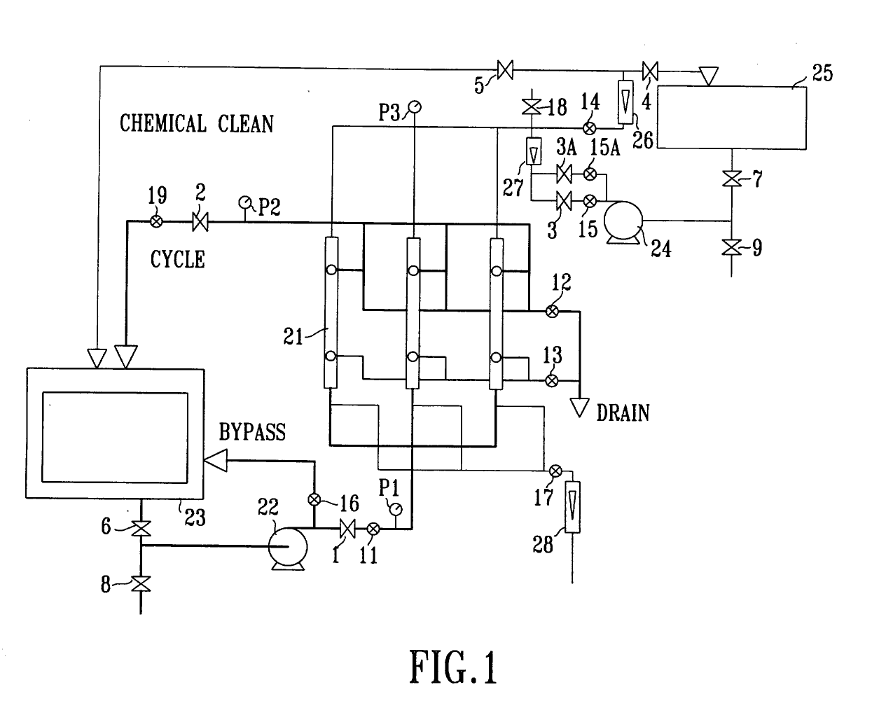

The system of the present invention is a modified design (see FIG. 1) based on the existing “External Compression Separating System for Hollow Fiber Membranes (a previously applied patent by the applicant, CN1333080A, called the membrane system for short). The added parts in the present invention include mainly the external pipelines such as the chemically cleaning loop, the dual backwash loop, and the bypass loop mentioned above, and combination of manual, pneumatic or automatic valves for the automatic control. Since the membrane assembly, control valves, pressure gauges, pumps, air compressor, tanks (feed liquid tanks), and connecting pipelines in the original membrane system are still adopted in the present invention, description of these parts has been omitted herein. The valves shown in FIG. 1 contain, according to their control mode, manual valves 1-9; pneumatic diaphragm valves 11-16, 19, also called automatic valves; a solenoid valve for compressed air 17; and a solenoid check valve 18.

Therein according to their functions, the valve 1 is called pressure control or regulating valve at the inlet; the valve 2-pressure control or regulating valve at the outlet; the valves 3, 3a-backwash control or backwash valve used for controlling the flow rate of cleaning liquid; the valves 4, 5-switchover valve used for switching over between the separating operation of the membrane and the chemically cleaning operation; the valve 6-inlet valve of the MF pump; the valve 7-inlet valve of the cleaning pump; the valves 8, 9-drain valve; the valve 11-automatic valve at the inlet; the valve 12-exhaust valve of cleaning air; the valve 13-drain valve of cleaning liquid; the valve 14-outlet valve of filtered liquid; the valves 15, 15a-automatic backwash valve; the valve 16-bypass valve of cleaning liquid or bypass valve; the valve 17-air intake valve; the valve 18-check valve for chemical feeding; and the valve 19-automatic outlet valve.

For simplicity hereinafter the valves with various functions will be called ‘valve X’ (X-number) for short.

The said modified design creates foundational equipment by which an operation mode for the new membrane system may be carried out, in other words, the operation mode for the membrane system described in the present invention will require some corresponding modification made in the existing membrane system. The operation mode of the new membrane system of the present invention is described as follows:

1. Operating status. Opening the valves 4, 6, 7, 11, 14, 19, with the other valves being closed; opening and controlling the valves 1 and 2 to achieve 0.05-0.20 MPa of the operating pressure at the inlet P1, 0.03-0.18 MPa of the outlet pressure P2 respectively, operating for 20-40 min.

Under the conditions based on the actual condition of the original water or the product and the requirements to be met, an oxidant may directly be fed through a metering pump (not shown in FIG. 1) into the original liquid tank of the membrane system, i.e. the cycle tank 23, to enhance the operating effect. The oxidant may be chlorine, ozone, chlorine dioxide or sodium hypochlorite with 1-10 ppm of condensation;

2. Cleaning status 1. Closing the automatic valves 11, 14, 19, opening the automatic valves 12, 15, 16, 17, opening and controlling the valve 3 to get a flow rate of cleaning liquid ¼-½ times as many that of filtered liquid, a reading of 0.02-6 Nm3/h (the filtering area per square meter of the membrane) in the gas flow meter 28. Cleaning for 10-60 secs.

In this cleaning status the oxidant may or not be used depending on the specific requirements. In order to facilitate the oxidant feeding the check valve for chemical feeding 18 is provided in the pipeline connecting the outlet valve of filtered liquid 14 to the top port of the membrane assembly. If necessary, the oxidant may be fed through the metering pump (not show in FIG. 1) and the valve 18 into the backwash or cleaning liquid system. The oxidant may be chlorine, ozone, chlorine dioxide, sodium hypochlorite with 1-1000 ppm of condensation depending on the specific requirements.

3. Cleaning status 2. Opening the valves 15a, 13, closing the valves 17, 18, controlling the valve 3a to acquire a flow rate of cleaning liquid ½-3/2 times as many as that of filtered liquid, with the other valves being in the same conditions as those in the cleaning status 1. Cleaning for 20 secs.-2 mins.

4. Drain status. Closing the valves 15, 15a, with the other valves being in the same conditions as those in the cleaning status 2, draining for 5-60 secs., until no dirty water flows out from the drain port.

5. Returning to the operation status. Starting a next cycle.

It should be noted that the original liquid must be pre-filtered through a filter of mesh #50 before it enters the membrane system to ensure a higher efficiency in the separating and cleaning process of the membrane.

Also, it should be indicated that depending on the actual situation after a 1-5 weeks operation of the membrane system, the membrane system shall be cleaned chemically. The chemical cleaning technology is of an existing technology. The chemical cleaning procedure adopted in the membrane system of the present invention includes feeding directly a chemical reagent into the MF cycle tank 23, closing the valve 4, opening the valve 5, and with the others being in the same as in the said operation status. The chemical reagent to be used for the chemical cleaning of the membrane system may include acids, bases, oxidants, surface-active agents or dedicated cleaning agents.

Specific examples of the embodiment of the present invention are stated as follows.

### EXAMPLE 1

The original liquid is pre-filtered underground water through a filter of mesh #50. The membrane system consists of a three 6″-hollow-fibre-membranes assembly of polyvinylidene fluoride (150 square meter filtering areas), a PLC program controller, solenoid valves, pneumatic diaphragm valves, an MF pump, a cleaning pump, tanks and other pipes and valves which are assembled in the system according to the scheme described in the present invention. This membrane system serves as a pre-treating device for a reverse osmosis membrane system, and to filter water for purification in the following procedures:

1. Operation style. Opening the valves 4, 6, 7, 11, 14, 19, closing other valves; opening and controlling the valves 1 and 2 to achieve 0.20 MPa of the operating pressure at the inlet P1, 0.18 MPa of the outlet pressure P2 respectively. Operating for 40 mins. with a flow rate of filtered liquid of 20 t/h.

2. Cleaning status 1. closing the automatic valves 11, 14, 19, opening the automatic valves 12, 15, 16, 17, 18, opening and controlling the valve 3 to get a flow rate of cleaning liquid of 7 t/h, a reading of 10 Nm3/h in the gas flow meter 28. Cleaning for 12 secs. In this cleaning status an oxidant is fed through the metering pump and the valve 18 into the cleaning system. A solution of 10% sodium hypochlorite is adopted as the oxidant which has a concentration of 200 ppm.

3. Cleaning status 2. Opening the valves 15a, 13, closing the valves 17, 18, controlling the valve 3a to acquire a flow rate of cleaning liquid of 16 t/h, with the other valves being in the same conditions as those in the cleaning status 1. Cleaning for 20 secs.

4. Drain status. Closing the valves 15, 15a, with the other valves being in the same conditions as those in the cleaning status 2. Draining for 5 secs.

5. Returning to the operation status.

Following a continuous 5-weeks operation, the membrane system shall be cleaned chemically using in turn sodium hypochlorite, acids and bases.

### EXAMPLE 2

The original liquid is pre-filtered surface water through a filter of mesh #50, BOD 8 ppm, COD 10 ppm, SS 5 pp. The same membrane system and application thereof in this example as in the Example 1 serves to filter the water for purification in the following procedures:

1. Operation status. Opening the valves 4, 6, 7, 11, 14, 19, closing the other valves; opening and controlling the valves 1 and 2 to achieve 0.05 MPa of the operating pressure at the inlet P1, 0.03 MPa of the outlet pressure P2 respectively. Operating for 30 mins. Feeding an oxidant into the original liquid system through the metering pump. A solution of 10% sodium hypochlorite is adopted as the oxidant which has a concentration of 5 ppm. The flow rate of filtered liquid is 10 t/h.

2. Cleaning status 1. Closing the automatic valves 11, 14, 19, opening the automatic valves 12, 15, 16, 17, opening and controlling the valve 3 to give a flow rate of cleaning liquid of 4 t/h, a reading of 10 Nm3/h in the gas flow meter 28. Cleaning for 40 secs.

3. Cleaning status 2. Opening the valves 15a, 13, closing the valve 17, controlling the valve 3a to acquire a flow rate of cleaning liquid of 8 t/h, with the other valves being in the same conditions as those in the cleaning status 1. Cleaning for 20 secs.

4. Drain status. Closing the valves 15, 15a, with the other valves being in the same conditions as those in the cleaning status 2. Draining for 35 secs.

5. Returning to the operation status.

Following a continuous 2-weeks operation, the membrane system shall be cleaned chemically using in turn sodium hypochlorite, acids and bases.

### EXAMPLE 3

The original liquid is pre-filtered living sewage through a filter of mesh #50, BOD 30 ppm, COD 20 ppm, SS 10 ppm. The same membrane system and application thereof in this example as in the Example 1 serves to filter the water for purification in the following procedures:

1. Operation status. Opening the valves 4, 6, 7, 11, 14, 19, closing the other valves; opening and controlling valves 1 and 2 to achieve 0.2 MPa of the operating pressure at the inlet P1, 0.18 MPa of the outlet pressure P2. Operating for 20 mins. Feeding an oxidant into the original liquid system through the metering pump. A solution of chlorine of 9 ppm is adopted as the oxidant. The flow rate of filtered liquid is 10 t/h.

2. Cleaning status 1. Closing the automatic valves 11, 14, 19, opening the automatic valves 12, 15, 16, 17, 18, opening and controlling the valve 3 to get a flow rate of cleaning liquid of 3 t/h, a reading of 20 Nm3/h in the gas meter 28. Cleaning for 58 secs. Under this condition feeding an oxidant for the cleaning process. Feeding the oxidant into the cleaning system through the metering pump and the valve 18. Chlorine of 500 ppm is adopted as the oxidant.

3. Cleaning status 2. Opening the valves 15a, 13, closing the valves 17, 18, opening and controlling the valve 3a to acquire a flow rate of cleaning liquid of 15 t/h, with the other valves being in the same conditions as those in the cleaning status 1. Cleaning for 1.9 mins.

4. Drain status. Closing the valves 15, 15a, with the other valves being in the same conditions as those in the cleaning status 2, draining for 58 secs.

5. Returning to the operation status.

Following a continuous 3-weeks operation, the membrane system shall be cleaned chemically using in turn sodium hypochlorite, acids, and bases.

### EXAMPLE 4

The original liquid is pre-filtered underground water through a filter of mesh #50. The same membrane system and application thereof in this example as in the Example 1 serves to filter the water for purification in the following procedures:

1. Operation status. Opening the valves 4, 6, 7, 11, 14, 19, closing the other valves; opening and controlling the valves 1 and 2 to achieve 0.05 MPa of the operating pressure at the inlet P1, 0.03 MPa of the outlet pressure P2. Operating for 40 mins. Feeding an oxidant into the original liquid system through the metering pump. A solution of 10% sodium hypochlorite may be used as the oxidant which has a concentration of 5 ppm. The flow rate of filter liquid is 10 t/h.

2. Cleaning status 1. Closing the automatic valves 11, 14, 19, opening the automatic valves 12, 15, 16, 17, 18, controlling the valve 3 to get a flow rate of cleaning liquid of 4 t/h, a reading of 10 Nm3/h in the gas flow meter. Cleaning for 10 secs. Under this condition feeding an oxidant for the cleaning process. Feeding the oxidant into the cleaning system through the metering pump and the valve 18. A solution of 10% sodium hypochlorite is adopted as the oxidant which has a concentration of 200 ppm.

3. Cleaning status 2. Opening the valves 15a, 13, closing the valves 17, 18, controlling the valve 3a to get a flow rate of cleaning liquid of 6 t/h, with the other valves being in the same conditions as those in the cleaning status 1. Cleaning for 10 secs.

4. Drain status. Closing the valves 15, 15a, with the other valves being in the same conditions as those in the cleaning status 2, draining for 6 secs.

5. Returning to the operation status.

Following a continuous 4-weeks operation, the membrane system shall be cleaned chemically using in turn sodium hypochlorite, acids, bases.

### EXAMPLE 5

The original liquid is pre-filtered surface water through a filter of mesh #50, BOD 8 ppm, COD 10 ppm, SS 5 ppm. The same membrane system and application thereof in this example as in the Example 1 serves to filter the water for purification in the following procedures:

1. Operation status. Opening the valves 4, 6, 7, 11, 14, 19, closing the other valves; opening and controlling the valves 1 and 2 to achieve 0.1 MPa of the operating pressure at the inlet P1, 0.08 MPa of the outlet pressure P2. Operating for 30 mins. The flow rate of filtered liquid is 10 t/h.

2. Cleaning status 1. Closing the automatic valves 11, 14, 19, opening the automatic valves 12, 15, 16, 17, 18, controlling the valve 3 to get a flow rate of cleaning liquid of 5 t/h, a reading of 10 Nm3/h in the gas flow meter. Cleaning for 40 secs. Under this condition feeding an oxidant for the cleaning process. Feeding the oxidant into the membrane system through the metering pump and the valve 18. A solution of chlorine dioxide which has a concentration of 1000 ppm is adopted as the oxidant.

3. Cleaning status 2. Opening the valves 15a, 13, closing the valves 17, 18, controlling the valve 3a to get a flow rate of cleaning liquid of 6 t/h, with the other valves being in the same conditions as those in the cleaning status 1. Cleaning for 1.2 mins.

4. Drain status. Closing the valves 15, 15a, with the other valves being in the same conditions as those in the cleaning status 2, draining for 46 secs.

5. Returning to the operation status.

Following a continuous 2-weeks operation, the membrane system shall be cleaned chemically using in turn sodium hypochlorite, acids, bases.

What is claimed is:

1. A separating system for hollow fiber membranes, which has a membrane assembly, control valves, pressure gauges, pumps, an air compressor, water tanks and pipelines connected, in addition, the separating system includes also:
a dual backwash loop which is a pipeline connecting a top port of the said membrane assembly to a cleaning pump (24) through a first branch and a second branch following a flow meter for cleaning liquid (27); wherein:
the first branch is designed to fill a small amount of cleaning liquid into the said membrane assembly (21) in combination with the membrane fiber cleaning function by vibration from compressed air; and
the second branch is designed to fill a relatively large amount of cleaning liquid in order to clean the membrane adequately.

2. The separating system for hollow fiber membranes according to claim 1, wherein:
said cleaning pump (24) is connected to a cleaning liquid tank (25) through an inlet valve of the cleaning pump (7) and to a drain valve (9) respectively;
the cleaning liquid tank (25) is connected to the top port of the said membrane assembly (21) through a switchover valve (4), a flow meter for filtered liquid (26) and an outlet valve of filtered liquid (14); and
the pipeline between the said switchover valve (4) and the flow meter for filtered liquid (26) is connected to a cycle tank (23) through a switchover valve (5).

3. The separating system for hollow fiber membranes according to claim 1, wherein:
a check valve (18) is provided for chemical feeding in the pipeline connecting the outlet valve of filtered liquid (14) to the top port of the said membrane assembly (21).

4. The separating system for hollow fiber membranes according to either claim 1, wherein:
a bypass loop which is designed to connect the pipeline between a pump (22) and a pressure control valve (1) with the cycle tank (23) through a bypass valve (16) serves to protect the pump (22) and make it keeping running during a backwash or cleaning process.

5. The separating system for hollow fiber membranes according to either claim 1, wherein:
a chemically cleaning loop refers to a pipeline between the switchover valve (4) and the flow meter for filtered liquid (26) which is connected to the cycle tank (23) through the switchover valve (5), and serves to clean the membrane system chemically.

6. The separating system for hollow fiber membranes according to claim 1, wherein:
a series combination of manual valves with automatic valves is adopted to form control valve groups.

7. An operating method for the external compression separating system for hollow fiber membranes according to claim 1 includes the following procedures:
(1) operation status of the separating system for the membranes:
regulating valves (1,2) in the cycle line to present 0.05-0.20 MPa of an operating pressure P1 at the inlet of the membrane assembly, and 0.03-0.18 MPa at the outlet thereof, operating for 20-40 mins.;
cleaning status 1:
controlling valves in the first branch of the dual backwash loop to obtain a flow rate of cleaning liquid, ¼-½ times as many as that of the filtered liquid, a reading of 0.02-6.0 Nm3/h in a gas flow meter (28); cleaning for 10-60 secs.;
cleaning status 2:
controlling valves in the second branch of the dual backwash loop to achieve a flow rate of cleaning liquid, ½-2 times as many as that of the filtered liquid, cleaning for 20 secs.-2 mins.;
drain status
closing the valves in the two branches of the dual backwash loop, draining for 5-60 secs.;
returning to the operation status.

8. The operating method for the external compression separating system for hollow fiber membranes according to claim 7, wherein:
(1) the operation status is accomplished by opening the valves (4, 6, 7, 11, 14, 19), with the other valves being closed, then controlling the valves (1, 2) in the cycle line; wherein the valve (4) is a switchover valve for the pipeline connecting the cleaning with the loops, the valve (6) is a valve provided in the pipeline connecting the cycle tank (23) and the pump (22), the valve (7) is an inlet valve in the pipeline connecting the cleaning liquid tank (25) with the cleaning pump (24), the valve (11) is a valve located in the pipeline to the entrance of the membrane assembly, the valve (14) is a valve in the pipeline between the switchover valve (4) and the exit of the membrane assembly, the valve (19) is a valve in the pipeline to the exit of the membrane assembly; the valve (1) is a valve in the pipeline between the pump (22) and the valve (11), the valve (2) is a valve in the pipeline between the valve (19) and the cycle tank (23);
(2) the cleaning status 1 is accomplished by closing the valves (11, 14, 19), opening the valves (12, 15, 16, 17), then opening and controlling the valve (3) in the first branch of the dual backwash loop; wherein the valve (12) is a valve controlling drain from the upper half of the membrane assembly, the valve (15) is an automatic valve in the first branch, the valve (16) is a valve in the bypass loop, the valve (17) is a valve in the pipeline connecting the lower half of the membrane assembly with a gas flow meter, the valve (3) is a manual valve in the first branch;
(3) the cleaning status 2 is accomplished by opening the valves (15a, 13), closing the valve (17), with the other valves being in the same conditions as those in the cleaning status 1, then opening and controlling the valve (3a) in the second branch of the dual backwash loop, wherein the valve (15a) is an automatic valve in the second branch, the valve (13) is a valve controlling drain from the lower half of the membrane assembly, the valve (3a) is a manual valve in the second branch.

9. The operating method for the external separating system for hollow fiber membranes according to claim 7 contains a following procedure:
in the cleaning status 1, opening the check valve for chemical feeding (18) to feed a chemical which may be chlorine, ozone, chlorine dioxide, sodium hypochlorite or hydrochloric acid which has a concentration of 1-1000 ppm.

10. The operating method for the external separating system for hollow fiber membranes according to claim 9 includes a following procedure: in the cleaning status closing the check valve for chemical feeding (18).

11. The separating system for hollow fiber membranes according to claim 2, wherein:
a check valve (18) is provided for chemical feeding in the pipeline connecting the outlet valve of filtered liquid (14) to the top port of the said membrane assembly (21).

12. The separating system for hollow fiber membranes according to either claim 2, wherein:
a bypass loop which is designed to connect the pipeline between a pump (22) and a pressure control valve (1) with the cycle tank (23) through a bypass valve (16) serves to protect the pump (22) and make it keeping running during a backwash or cleaning process.

13. The separating system for hollow fiber membranes according to either claim 3, wherein:
a bypass loop which is designed to connect the pipeline between a pump (22) and a pressure control valve (1) with the cycle tank (23) through a bypass valve (16) serves to protect the pump (22) and make it keeping running during a backwash or cleaning process.

14. The separating system for hollow fiber membranes according to either claim 11, wherein:
a bypass loop which is designed to connect the pipeline between a pump (22) and a pressure control valve (1) with the cycle tank (23) through a bypass valve (16) serves to protect the pump (22) and make it keeping running during a backwash or cleaning process.

15. The separating system for hollow fiber membranes according to either claim 2, wherein:
a chemically cleaning loop refers to a pipeline between the switchover valve (4) and the flow meter for filtered liquid (26) which is connected to the cycle tank (23) through the switchover valve (5), and serves to clean the membrane system chemically.

16. The separating system for hollow fiber membranes according to either claim 3, wherein:
a chemically cleaning loop refers to a pipeline between the switchover valve (4) and the flow meter for filtered liquid (26) which is connected to the cycle tank (23) through the switchover valve (5), and serves to clean the membrane system chemically.

17. The separating system for hollow fiber membranes according to either claim 11, wherein:
a chemically cleaning loop refers to a pipeline between the switchover valve (4) and the flow meter for filtered liquid (26) which is connected to the cycle tank (23) through the switchover valve (5), and serves to clean the membrane system chemically.

18. The separating system for hollow fiber membranes according to claim 2, wherein:
a series combination of manual valves with automatic valves is adopted to form control valve groups.

19. The separating system for hollow fiber membranes according to claim 3, wherein:
a series combination of manual valves with automatic valves is adopted to form control valve groups.

20. The separating system for hollow fiber membranes according to claim 11, wherein:
a series combination of manual valves with automatic valves is adopted to form control valve groups.

21. The separating system for hollow fiber membranes according to claim 4, wherein:
a series combination of manual valves with automatic valves is adopted to form control valve groups.

22. The separating system for hollow fiber membranes according to claim 12, wherein:
a series combination of manual valves with automatic valves is adopted to form control valve groups.

23. The separating system for hollow fiber membranes according to claim 13, wherein:
a series combination of manual valves with automatic valves is adopted to form control valve groups.

24. The separating system for hollow fiber membranes according to claim 14, wherein:
a series combination of manual valves with automatic valves is adopted to form control valve groups.

25. The separating system for hollow fiber membranes according to claim 5, wherein:
a series combination of manual valves with automatic valves is adopted to form control valve groups.

26. The separating system for hollow fiber membranes according to claim 15, wherein:
a series combination of manual valves with automatic valves is adopted to form control valve groups.

27. The separating system for hollow fiber membranes according to claim 16, wherein:
a series combination of manual valves with automatic valves is adopted to form control valve groups.

28. The separating system for hollow fiber membranes according to claim 17, wherein:
a series combination of manual valves with automatic valves is adopted to form control valve groups.

29. The operating method for the external separating system for hollow fiber membranes according to claim 8 contains a following procedure:
in the cleaning status 1, opening the check valve for chemical feeding (18) to feed a chemical which may be chlorine, ozone, chlorine dioxide, sodium hypochlorite or hydrochloric acid which has a concentration of 1-1000 ppm.

30. The operating method for the external separating system for hollow fiber membranes according to claim 29 includes a following procedure: in the cleaning status closing the check valve for chemical feeding (18).
